(19) United States
(12) Patent Application Publication
(10) Pub. No.: US 2014/0025974 A1
(43) Pub. Date: Jan. 23, 2014

(54) INFORMATION PROCESSING APPARATUS, SERVER AND METHOD OF CONTROLLING THE SAME

(71) Applicant: CANON KABUSHIKI KAISHA, TOKYO (JP)

(72) Inventor: Takeshi Suwabe, Tokyo (JP)

(21) Appl. No.: 13/936,916

(22) Filed: Jul. 8, 2013

(30) Foreign Application Priority Data
Jul. 17, 2012 (JP) 2012-159077

(51) Int. Cl. G06F 1/32

(52) U.S. Cl. CPC G06F 1/3234
USPC 713/323

(57) ABSTRACT

A periodic update time is saved on an SRAM 213 and an auto-shutdown time is saved on the SRAM 213. When the saved auto-shutdown time is reached, if the periodic update time is set to a time that is after auto-shutdown, a shutdown is not performed, a return time is set to a time that is before the periodic update time, and a sleep mode is entered. A return from sleep is performed at a return time and the periodic update is carried out.

### BACKGROUND OF THE INVENTION

1. Field of the Invention

The present invention relates to an information processing apparatus that efficiently performs power control for realizing power conservation and periodic updates of firmware and the like in an information processing apparatus for example, a server and a method of controlling the same.

2. Description of the Related Art

Firmware (or software) included in an information processing apparatus or the like is often updated, and these updates are often delivered via a network. Functions for periodically performing automatic updating (to be referred to a periodic update functions hereinafter) in order to update firmware (or software) to the latest version are widely known. Note that firmware refers to programs or data that are fixed in a ROM, and in the present specification, it refers in particular to programs (or data) written in a ROM that is re-writable. Since the present invention is also applicable to software that is stored in file storage, extracted to a RAM and executed, firmware and software will be called “firmware”, and the expression “firmware update” will be used for firmware updates and software updates.

It has become standard for office machines to include periodic update functions and execute firmware updates during the night. On the other hand, it is evident, particularly in offices with multiple office machines, that power-conserving functions are positioned as important functions. Methods such as automatically shutting down and going into a sleep state in which necessary contexts are saved and the power supply is partially stopped are typically performed as power-conserving functions during the night. Examples of automatic shutdown functions include a fixed-time scheduled shutdown function in which a shutdown is performed at a pre-set time, a day-of-week scheduled shutdown in which a shutdown is performed at a certain time on a certain day of the week, and the like. Additionally, a remote shutdown function in which shutdown can be performed remotely is also realized as a power-conserving function. Also, regarding sleep, the below-described technique became commonly known due to Japanese Patent Laid-Open No. 2011-113501. According to this document, when a scheduled sleep timer expires, the time of reception of the next packet from the network is predicted from the packet reception interval, and if the reception of a packet after transitioning to a sleep state is predicted, an extension timer is set and sleep transition is delayed, otherwise sleep transition will occur. This processing is performed each time the sleep timer expires.

However, the technique disclosed in Japanese Patent Laid-Open No. 2011-113501 is specialized for a technique in which pre-existing information (packet reception interval) is stored, reception of a packet is predicted, and the sleep transition time is shifted. That is to say, a firmware update is not mentioned, and only a shift of time is performed with respect to sleep transition. Additionally, since only a shift of time is performed, it cannot be said that an optimal power-conservation technique is provided.

### SUMMARY OF THE INVENTION

The present invention has been achieved in view of the aforementioned problems, and it provides a mechanism that efficiently realizes a firm update and conservation of power simultaneously.

According to one aspect of the present invention, there is provided an information processing apparatus having a sleep function that stops a supply of power to a part of the information processing apparatus excluding at least a clock unit, comprising: a scheduled update unit configured to carry out program update processing at a scheduled update time; an auto-shutdown unit configured to determine whether the update time is set if a shutdown condition is satisfied, sets an alarm time that is earlier than the update time in the clock unit and transitions to a sleep state using the sleep function if the update time is set, and if the update time is not set, stops a supply of power to the entire information processing apparatus; and a return unit configured to cause the information processing apparatus to return from the sleep state to an operation state when the clock unit reaches the set alarm time, wherein the auto-shutdown unit stops a supply of power to the entire information processing apparatus after a return from the sleep state is performed and update processing carried out by the scheduled update unit ends.

Alternatively, according to another aspect of the present invention, there is provided a server that can be communicably connected with an information processing apparatus, the server comprising: a unit configured to store a schedule that includes a shutdown time at which shutdown processing for stopping a supply of power to the information processing apparatus is performed, and an update time at which update processing for updating a program of the information processing apparatus is carried out; a unit configured to determine, with reference to the schedule, whether the update processing is to be carried out after the shutdown time; a unit configured to re-set the schedule such that, in a case where it is determined that the update processing is to be carried out after the shutdown time, the update time is earlier than the shutdown time; and a unit configured to transmit the schedule to the information processing apparatus.

According to the present invention, an update of programs and the like can be performed with a designated schedule, and efficient conservation of power can be realized. Also, even in a system in which multiple devices are managed, updates of programs and the like, as well as efficient power conservation can be performed simultaneously over the entire system since updates of programs and the like and the auto-shutdown schedule are adjusted for the overall system.

Further features of the present invention will become apparent from the following description of exemplary embodiments with reference to the attached drawings.

### BRIEF DESCRIPTION OF THE DRAWINGS

FIG. 1 is an example of a block diagram of an information processing apparatus 100.

FIG. 2 is an example of a diagram that shows energization states of the information processing apparatus 100 during sleep.

FIG. 3 is an example of a diagram that shows energization states of the information processing apparatus 100 during shutdown.

FIG. 4 is an example of a diagram of an update system configuration centered around a flash ROM 219.

FIGS. 5A, 5B, and 5C are diagrams showing examples of time charts for auto-shutdown and scheduled update.

FIG. 6 is a diagram showing an example of a scheduled update setting screen displayed on an operation unit 220.

FIG. 7 is a diagram showing an example of an auto-shutdown setting screen displayed on the operation unit 220.

FIG. 8 is a flowchart showing a procedure of auto-shutdown processing.

FIGS. 9A, 9B, and 9C are diagrams showing examples of time charts for auto-shutdown and scheduled update.

FIG. 10 is a diagram showing an example of a scheduled update setting screen displayed on the operation unit 220.

FIG. 11 is a diagram showing an example of a scheduled update setting screen displayed on the operation unit 220.

FIGS. 12A and 12B are flowcharts showing a procedure of auto-shutdown processing.

FIGS. 13A and 13B are diagrams showing examples of time charts for auto-shutdown and scheduled update.

FIGS. 14 and 15 are flowcharts showing a procedure of re-scheduling a scheduled update in a server.

### DESCRIPTION OF THE EMBODIMENTS

### Embodiment 1

Embodiment 1 for implementing the present invention will be described below with use of the drawings. In the present embodiment, when conditions for shutdown are satisfied in a state in which periodic update processing is scheduled, for example, when a shutdown time that is pre-set as a condition for shutdown is reached, a shutdown in which the power supply of the whole apparatus is cut off is not performed, and the apparatus transitions to a sleep state in which power supply is cut off to parts of the apparatus other than parts such as a CPU, a timer, or an input panel. The sleep state is a state in which power is supplied to parts that are central to control of the apparatus, such as a CPU (or a device used for operation of the CPU, including a memory, a bus, and the like) and a real time clock (RTC), and such parts can, using a timer interrupt or the like as a trigger, resume the supply of power to the whole system so as to restart it.

Configuration of Information Processing Apparatus

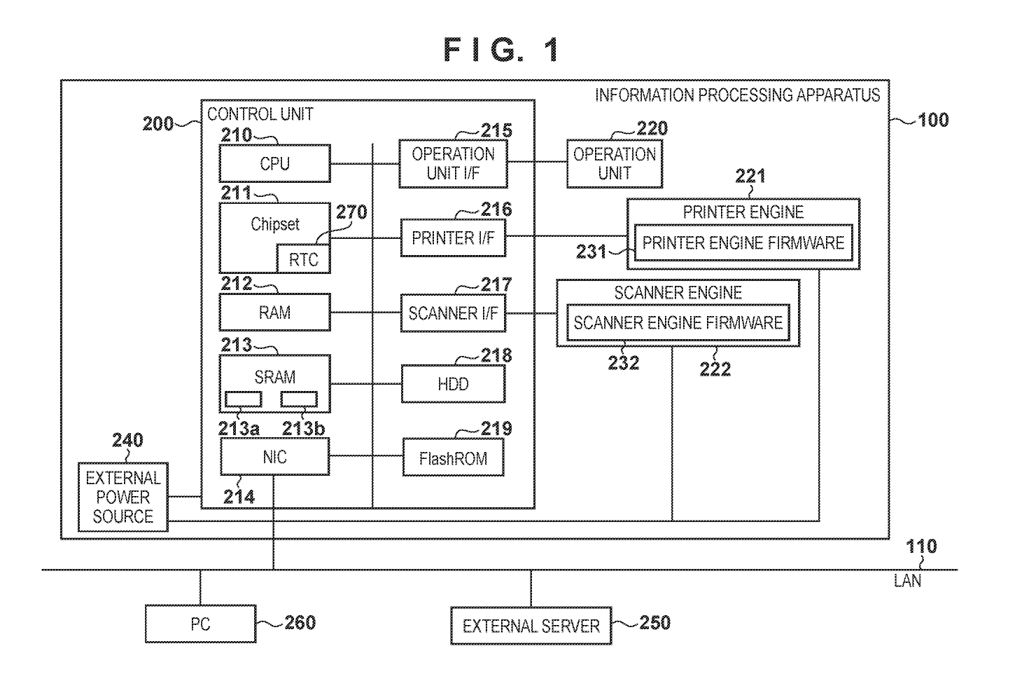

FIG. 1 is an example of a block diagram of an information processing apparatus 100. Note that what is referred to as an information processing apparatus in the present embodiment is a multifunction copying machine. However, the present embodiment can be applied to another type of apparatus such as a general-purpose computer, as long as it is an apparatus that has a sleep function and a scheduled update (automatic update) function in which programs and the like are updated at a scheduled time. Also, in the present example, an update of firmware written in an executable format on an electrically erasable and rewritable memory will be described as an example, but the present invention can be applied to updates of programs or data, including software that is stored on a file storage such as a hard disk as well.

A control unit 200, which includes a CPU 210, performs overall control of operations of the information processing apparatus 100. The CPU 210 reads out a control program stored on a flash ROM 219 and executes various types of control processing such as scan control, print control, and firmware update control. Additionally, the flash ROM 219 is also used as a firmware update file storage area, a work area, and a user data area. A RAM 212 is used as a main memory of the CPU 210, and a temporary storage area such as a work area. An SRAM 213 is a memory that is backed up with a battery or the like and stores setting values and image adjustment values that will be needed in the information processing apparatus 100, and therefore data stored therein does not disappear even if power is cut off and reintroduced. In the present example, the SRAM 213 includes, in particular, an area that stores a set time 213a of scheduled update processing and a set time 213b of scheduled shutdown processing. Rather than being limited to one, multiple times can be set for each time. An HDD 218 stores image data, user data, and the like, as well as programs. There are also cases in which the HDD 218 is not connected.

An operation unit I/F 215 connects an operation unit 220 and the control unit 200. A keyboard, a liquid crystal display unit that has a touch panel function, and the like, are provided in the operation unit 220. A printer I/F 216 connects a printer engine 221 and the control unit 200. Printer engine firmware 231 is stored in a ROM (not shown) included in the printer engine 221. Image data to be printed with the printer engine 221 is transferred from the control unit 200 to the printer engine 221 via the printer I/F 216, and is printed on a recording medium in the printer engine 221. A scanner I/F 217 connects a scanner engine 222 and the control unit 200. Scanner engine firmware 232 is stored in a ROM (not shown) included in the scanner engine 222. The scanner engine 222 scans an image on an original, generates image data, and inputs the data to the control unit 200 via the scanner I/F 217. A network I/F card NIC 214 connects the control unit 200 (information processing apparatus 100) to a LAN 110. The NIC 214 transmits image data and information to external apparatuses (e.g., an external server 250 and a PC 260) on the LAN 110, and conversely, receives update firmware and various types of information. There are also cases in which the external server 250 exists on the Internet. Sometimes operations of the information processing apparatus 100 are performed from a web browser (not shown) that exists on the PC 260.

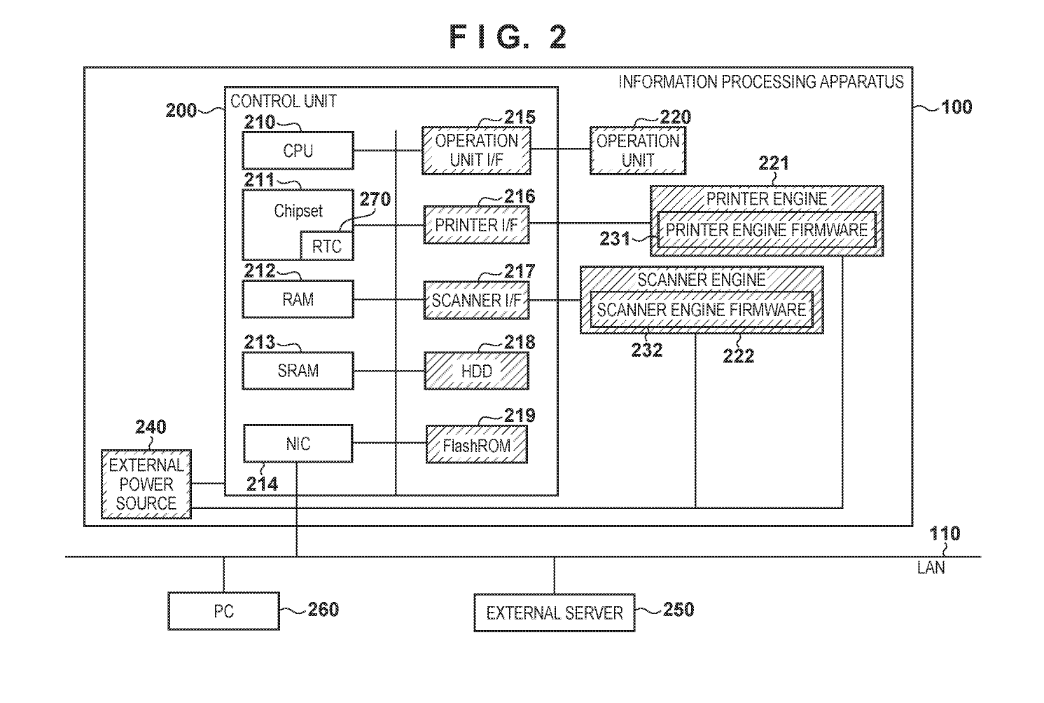

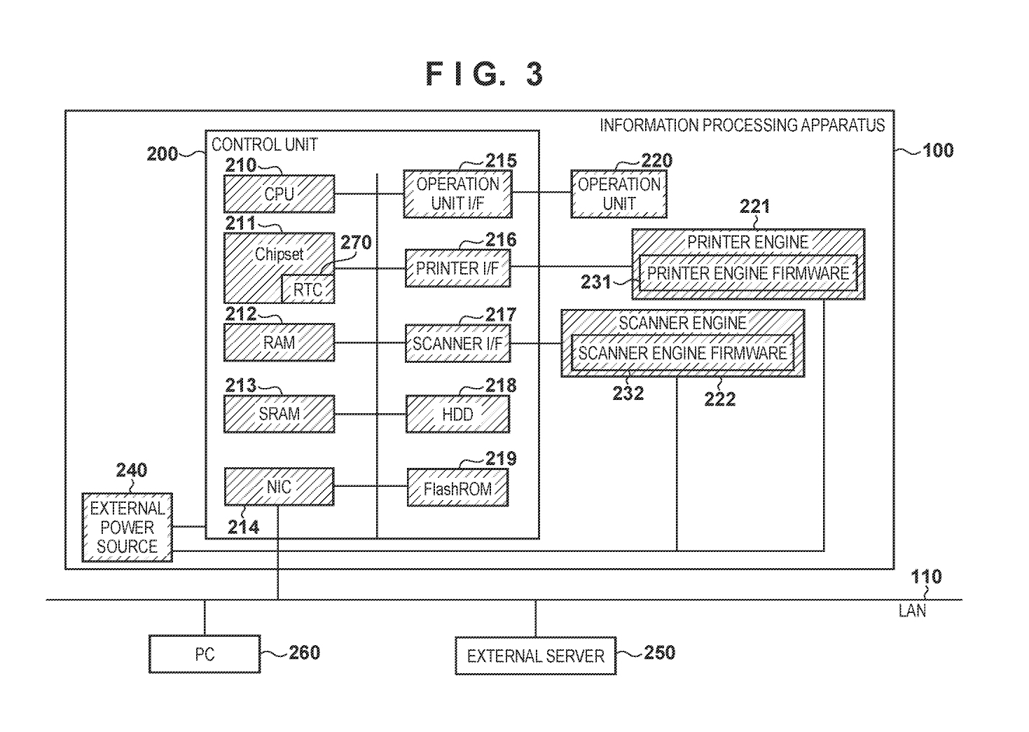

A chipset 211 refers to a series of multiple related integrated circuits. An RTC 270 is a real time clock, and a chip for keeping time. It is also called a clock unit. Even if an external power source 240 is not connected, the RTC 270 receives a supply of power from a built-in battery (not shown), and therefore, it operates even during power cutoff and during sleep. Also, a return from a sleep state can be realized as long as part of the power is supplied to a circuit, such as the CPU 210 or the chipset 211, that is needed in order to return to an operation state (standby state) when in a sleep state. Conversely, when in a shutdown state in which the power supply to the entire information processing apparatus is stopped and power is not supplied at all to the chipset 211, although the RTC 270 is operational, a return to the operation state cannot be performed since other parts are not operational. Power supply states are shown in FIGS. 2 and 3.

FIG. 2 is a diagram showing energization states during sleep. Among the units of the information processing apparatus 100, the CPU 210, the chipset 211 (including the RTC 270), the RAM 212, the SRAM 213, and the NIC 214 receive a supply of power from the power source 240 and are energized. The flash ROM 219, the HDD 218, and the like, which are indicated with hatching, are in a non-energized state. With a return from the sleep state to the standby state (operation state), the CPU 210 operates according to the time control of the RTC 270 for example, and the other blocks, such as the flash ROM 219 are energized. Note that in a case where processing to return to the operation state at a pre-set time is performed, if the RTC 270 has a function that outputs an alarm signal when the set time is reached, that alarm signal can be used as a trigger, and if not, the CPU 210 determines that the set time has been reached by polling the RTC 270 periodically. Also, it is conceivable that the return is caused not only by time control according to the RTC 270, but also by a return request (e.g., a multicast packet) according to the network protocol, a return request due to an incoming fax, or the like, via the NIC 214.

FIG. 3 is a diagram showing energization states during shutdown. It differs from FIG. 2 in that all of the blocks that configure the control unit 200 are in a non-energized state. In this case, a return according to time control of the RTC 270 or a return according to a network protocol or the like cannot be implemented, as shown in FIG. 2. However, as described above, the RTC 270 and the SRAM 213 are backed up by a battery.

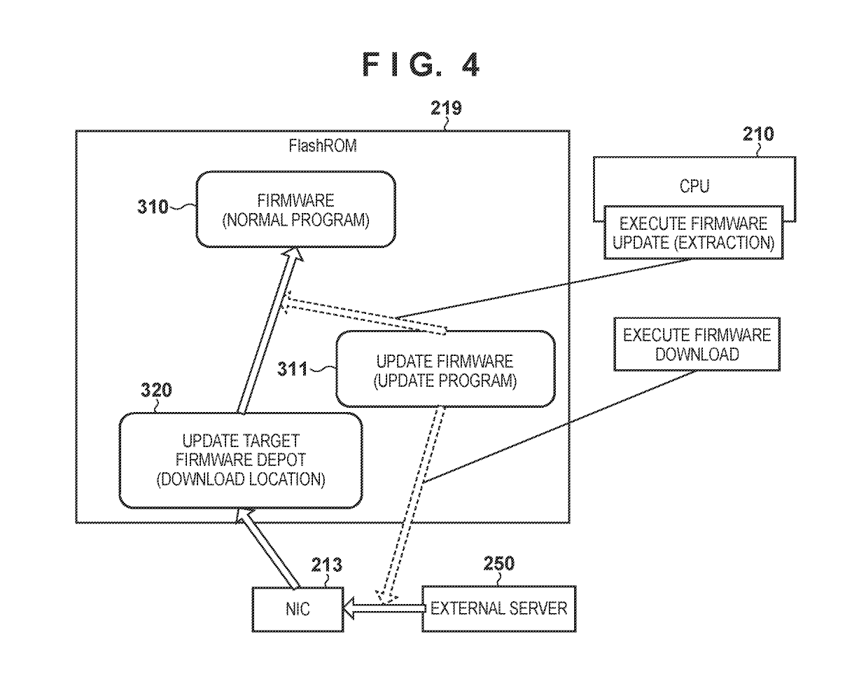

FIG. 4 is an example of a diagram showing a configuration of the flash ROM 219. Firmware 310 is a program that causes various functions, as shown in FIG. 1, to operate and in the present example, it is the target of updating. Update firmware 311 is a program that performs update processing, and it is a program that performs processing for updating the firmware 310. An update target firmware depot 320 is a location for storing firmware downloaded via the NIC 214, which was shown in FIG. 1. The update target firmware depot 320 can be referenced from both the firmware 310 and the update firmware 311. The update firmware 311 is executed by the CPU 210, and downloads update target firmware (i.e., new firmware) from the external server 250. Thus, update target firmware from the external server 250 is placed in the update target firmware depot 320 through the NIC 213. Subsequently, the update firmware 311 is executed by the CPU 210 and carries out a firmware update.

Timing of Scheduled Update Processing and Scheduled Shutdown Processing

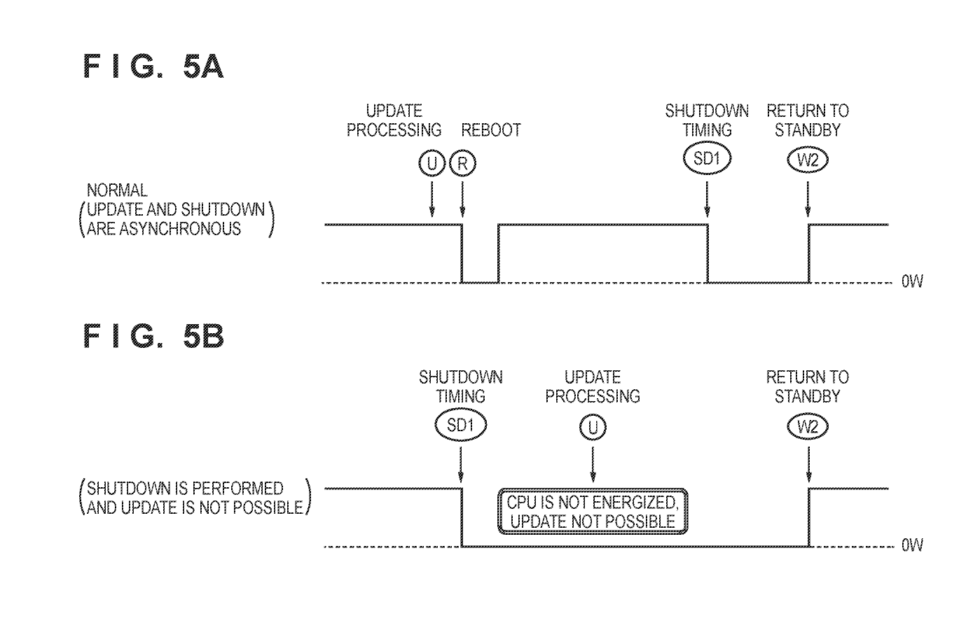

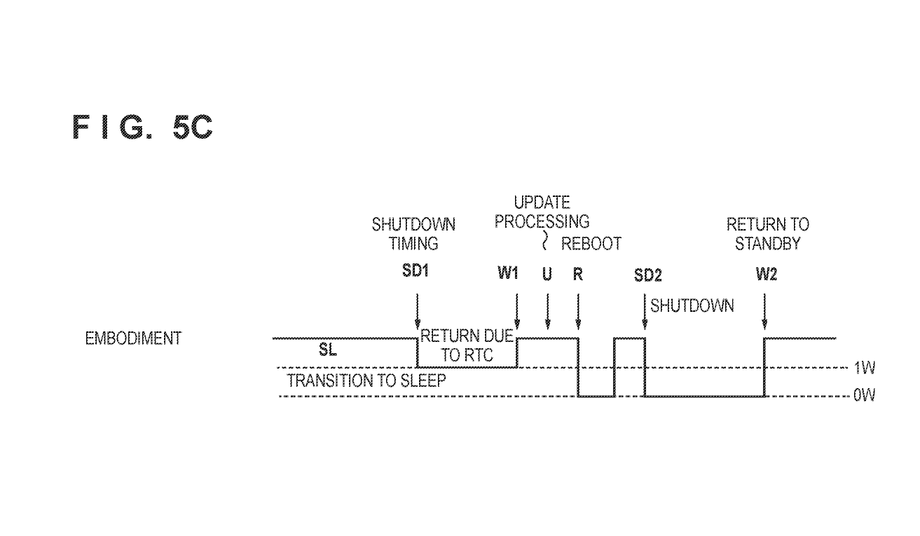

FIGS. 5A, 5B, and 5C are examples of diagrams showing time charts for update and shutdown in the information processing apparatus 100. Mainly, they are related to a case where when conditions for shutdown are put on hold in a state in which periodic update processing is scheduled, a transition to sleep is performed instead of a shutdown when a shutdown time has been reached, for example.

The time chart in FIG. 5A will be described below. This is a time chart for when normal update processing and a shutdown are performed. Update processing U and reboot (system restart) processing R are executed in a period of time that is not the period of time from shutdown timing SD1 to standby return W2. Because of this, a state is shown in which update processing is performed normally, regardless of the shutdown timing.

The time chart in FIG. 5B will be described next. This is a timing diagram relating to the problem-to-be-solved of the present invention. Here, the timing of the update processing U is reached during the period from the shutdown timing SD1 to the standby return W2, that is to say, in a state in which the power supply to the apparatus is stopped overall, and the CPU 210 and the like are not being energized, as shown in FIG. 3. Because of this, a firmware update cannot be performed at a scheduled time. The method shown in FIG. 5C resolves this kind of case.

The time chart in FIG. 5C will be described next. Here, a method related to the present embodiment will be described in which effective power control is performed when a shutdown timing is reached during a state in which a periodic update is scheduled. At a shutdown timing SD1, which is stored in advance in the SRAM 213, if the update time of a scheduled update is similarly stored in the SRAM 213, a shutdown is not carried out, but rather a transition to a sleep state SL is implemented. At this time, the CPU 210 sets the update time in the RTC 270. As a result of this, at the timing of the scheduled update, the RTC 270 detects the update time, and the apparatus returns to the standby state W1 from the sleep state. Note that this procedure is premised on an alarm function of the RTC, as described above. Then the update processing U is carried out. After update processing U is carried out, reboot (restart) processing is carried out. Then, instantaneous shutdown SD2 is carried out. Subsequently, standby return W2 is performed due to operations such as input of electricity.

Setting of a Scheduled Update Time

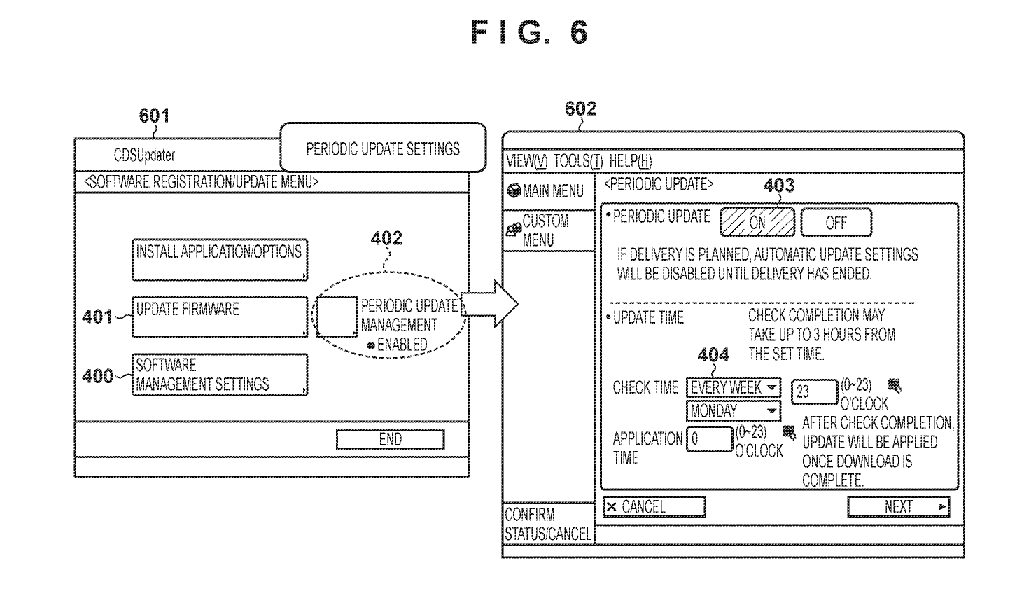

Next, an example of a display of the operation unit 220 of the information processing apparatus 100 will be described with reference to FIG. 6. FIG. 6 shows an example of periodic update settings. Note that although it is referred to as a periodic update, it can also be scheduled as an update that is performed only one time. In consideration of that point, it is sometimes called a scheduled update, but they are both the same thing. FIG. 6 shows a screen 601 of a main menu for updates. When a software management settings key 400 is pressed, a screen (not shown) appears on which the IP address and the like of the external server 250 to be connected to is input, and after that, the IP address and the like are input. A firmware update key 401 is a key that is used when instantaneous update is to be performed. When this key is pressed, update processing is started immediately. A periodic update management key 402 is a key for proceeding to a periodic update settings screen 602 of the present embodiment. When this key is pressed, the screen 602 is displayed, and periodic update setting can be performed. When setting for a periodic update is to be performed, an On key 403 is pressed, and in an update time setting field 404, setting values are received in fields for setting the day of the week and time at which it will be checked whether or not new firmware is on the external server 250, and the time that the update will actually be applied. By inputting the respective information, the periodic update time (i.e., the set time of the scheduled update) is set as the set time 213a of the SRAM 213 by the CPU 210.

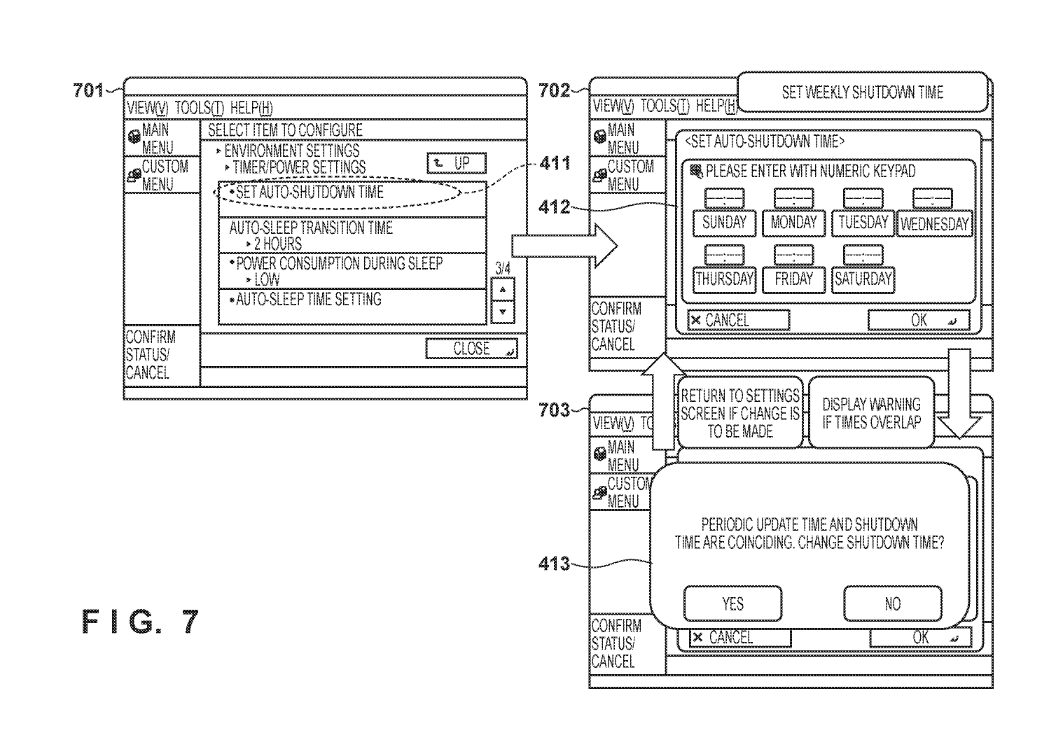

Next, in FIG. 7, an example of a display of the operation unit 220 will be described, in a case in which settings are performed for auto-shutdown and weekly shutdown (i.e., a shutdown that is carried out cyclically) in particular in the present embodiment. In FIG. 7, an auto-shutdown time setting key 411 is selected from a power settings screen 701, and the display transitions to a screen 702. On the screen 702, an auto-shutdown time setting field 412 shows an example of a screen for setting the cyclical timing at which shutdown is to be performed. For example, a time on Sunday, a time on Saturday, and so forth are set in the SRAM 213. Although an example of weekly shutdown settings is displayed on the screens 701 and 702, there are cases in which automatic shutdown settings that perform shutdown simply according to a timer are performed, or shutdown is performed remotely from a web browser of the PC 260.

On the screen 702, when a shutdown time is set, the periodic update time that was set with the screen 602 in FIG. 6 and saved on the SRAM 213 is read out, and if an update time is set to a time that is after the shutdown time, a warning screen 703 is displayed. Here, a pop-up screen 413 that allows a user to select whether or not to change the shutdown time is displayed on the control unit 220, and if settings are to be performed, the display transitions to the screen 702, and a screen that allows the user to re-set the shutdown time is displayed on the operation unit 220. Note that update processing takes a limited required time, and therefore, if an update time is set such that update processing is performed after the shutdown time, re-setting of the shutdown time may be permitted. In such a case, re-setting is permitted as long as the time obtained by adding the required duration to the set time of the periodic update is after the shutdown time. The required time for update processing is pre-set as 3 hours at most, for example.

Procedure of Shutdown Processing

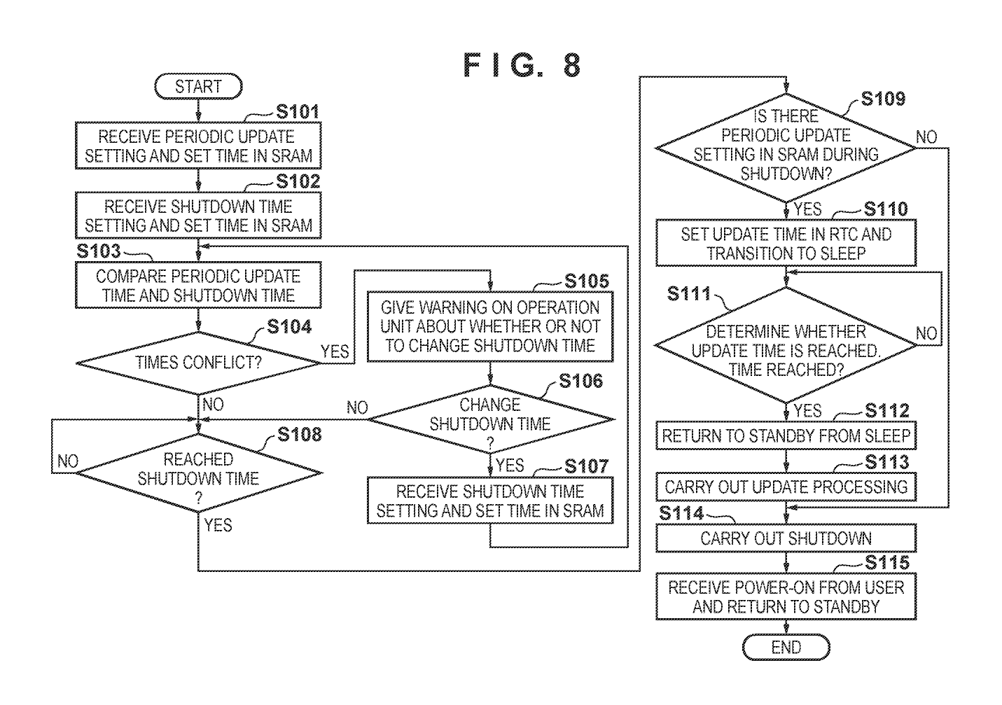

A flowchart of the case where shutdown timing is reached in the state in which periodic update processing is scheduled will be described with reference to FIG. 8. This procedure is accomplished by the CPU 210 executing a program stored in a flash ROM or the like.

In step S101, as shown in FIG. 6, the CPU 210 receives periodic update settings from the user and stores the set time 213a in the SRAM 213. In step S102, as shown in FIG. 7, the CPU 210 receives shutdown settings from the user and stores the set time 213b in the SRAM 213. Next, in step S103, given that times were set in steps S101 and S102, the CPU 210 reads out the periodic update time and the shutdown time from the SRAM 213 and compares the times. In step S104, it is determined whether or not they are settings according to which the periodic update will be performed at a time that is the same as the shutdown time or after the shutdown time. If it is such a setting, as shown in FIG. 7, a warning screen showing that it is a setting according to which the update is to be performed after shutdown is displayed on the operation unit 220 in step S105. In step S106, it is determined whether or not shutdown time settings will be changed in response to that notice, based on input from the user. If they will be changed, in step S107, the CPU 210 re-receives shutdown time settings and the time is re-set in the SRAM 213. If they will not be changed in step S106, the processing continues to step S108. The processing also continues to step S108 if there is no time conflict in step S104. At this point, time setting processing is complete. Although steps S108 and onward are shown in succession to steps S101 to S107 in FIG. 8, this is for convenience in the description, and they are asynchronous with the processing in steps S101 to S107.

In step S108, the time is read out from the RTC 270, and the CPU 210 compares it with the set time of scheduled shutdown and determines whether or not the shutdown time has been reached. If the shutdown time has not been reached, the processing returns to step S108. Note that if it is determined that the time has not been reached, it is preferable that this loop in step S108 is realized with processing in which an appropriate timer is set, the task pertaining to the processing of FIG. 8 ends, and the task is resumed from step S108 when the timer expires. The same follows for other steps in which it is determined that a set time has been reached. If the shutdown time has been reached, the processing continues to step S109, and in the SRAM 213, it is determined, with reference to the set time 213a, whether the periodic update is set to a time that is after shutdown processing (timing SD1 in FIG. 5C). If a periodic update has been set, the processing continues to step S110, and an alarm is set in the RTC 270 with the update time (return time for updating), and the transition to the sleep state is performed. The sleep state is a state in which only some of the blocks of the information processing apparatus 100 are energized (e.g., at a power consumption of 1 W), as shown in FIG. 2. Subsequently, the processing continues to step S111, and it is determined by the RTC 270 whether or not the update time (return time for updating) has been reached. If it has not been reached, the determination is repeated. Note that if an update setting time alarm is set in the RTC 270, the processing in step S111 is not needed, and the processing can be resumed from step S112 with an interrupt from the alarm. In any case, if the update set time has been reached, the processing continues to step S112, and a return from the sleep state (FIG. 2) to the standby state (FIG. 1) is performed according to an instruction from the CPU 210 (timing W1 in FIG. 5C). Then, subsequently, update processing is carried out in step S113. Then, when the update processing ends, shutdown processing is carried out in step S114 (0 W is reached here) (timing of SD2 in FIG. 5C). Also, if there is no periodic update setting in step S109, the processing continues to step S114, and shutdown is similarly carried out. Then, when power is switched on by the user in step S115, a return to standby is performed (timing of W2 in FIG. 5C).

Due to the aforementioned configuration and procedures, it is possible to achieve scheduled update processing during the operation state in which the power supply is input, and scheduled shutdown processing can be achieved while avoiding the period of the update processing. Also, during the period from the planned time of shutdown up to the set time of update processing, the apparatus is in the sleep state, and therefore, an update can executed on schedule, and power consumption can be suppressed.

Note that in step S107 in FIG. 8, the set time of shutdown is re-set, but the present embodiment is not limited to this, and the set time of update may be re-set or both may be re-set.

### Embodiment 2

Embodiment 2 for implementing the present invention will be described below with use of the drawings. The present embodiment is related to a case in which power is efficiently controlled when a shutdown timing is reached during a state in which periodic update processing is scheduled, and a predicted time of return to standby is earlier than an update time. In other words, in the present embodiment, a scheduled update is achieved at a set time with consideration additionally given to a planned power-on time, at which a return to the standby state is performed by turning the power on after shutdown (also called a predicted return time). Note that in the present embodiment, not just a return from the sleep state to the operation state, but also a return from the shutdown state to the operation state are referred to as a return or a standby return. Note that when distinguishing between a return from the shutdown state and a return from the sleep state, the former is referred to as a power re-input.

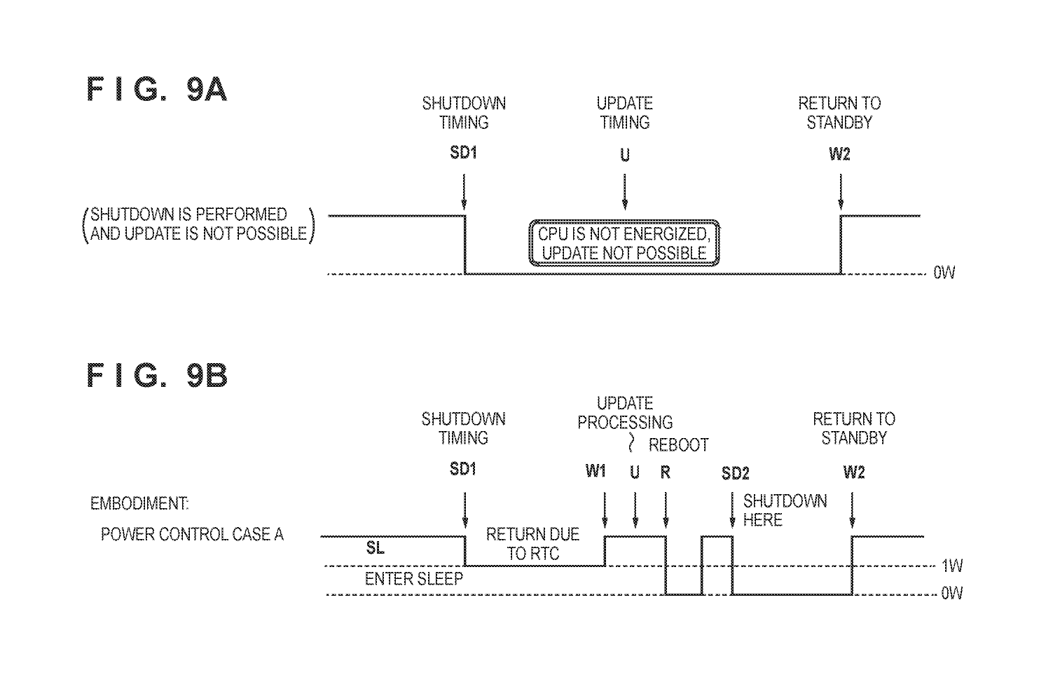

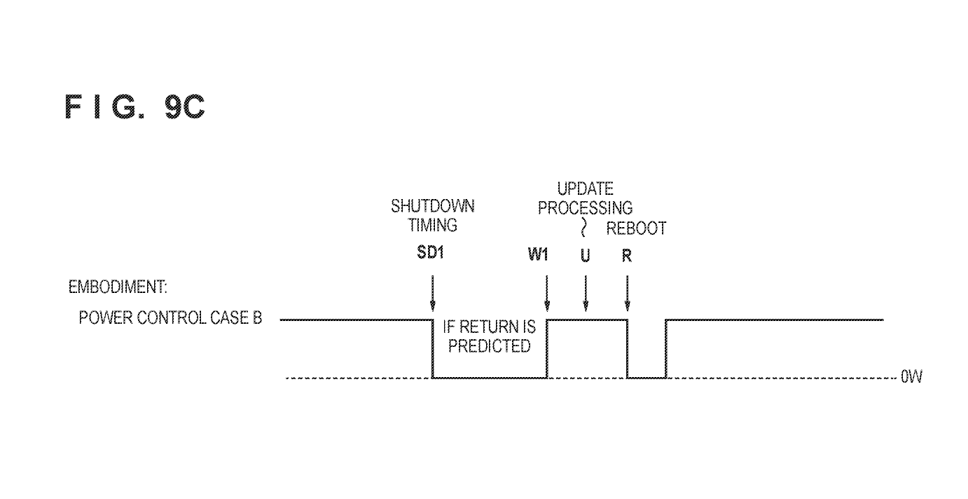

Since the units in FIGS. 1, 2, 3, and 4 are similar to those of Embodiment 1, they will not be described. FIG. 9A, FIG. 9B, and FIG. 9C are examples of diagrams showing time charts of the information processing apparatus 100.

The time chart in FIG. 9A is similar to FIG. 5B of Embodiment 1, and the timing of update processing U is reached during the period between the shutdown timing SD1 and the standby return W2. Because of this, at the set time of update processing, the information processing apparatus enters a state in which the CPU 210 and the like are not energized, as shown in FIG. 3 of Embodiment 1, and it enters a state in which a firmware update cannot be performed. The methods shown in FIGS. 9B and 9C are for resolving this type of case.

The time chart in FIG. 9B is similar to FIG. 5C of Embodiment 1, and when the shutdown timing SD1 is reached during a state in which a periodic update is scheduled, shutdown is not performed, and sleep transition SL is implemented.

The time chart in FIG. 9C relates to a case in which a return from shutdown is stored in the SRAM 213 as a predicted return time, and a return to standby is planned earlier than update processing U. Although the periodic update is scheduled in the SRAM 213, in the case where the predicted return time W1 is scheduled at a timing that is earlier than the timing of the periodic update U, the information processing apparatus 100 is expected to be in the operation state at the set time of update processing. In view of this, shutting down rather than entering the sleep state during that time results in less power consumption. Accordingly, shutdown is performed at the timing of SD1, standby return is performed at W1, update processing U is performed, and reboot processing R is performed.

Setting of Scheduled Update Time

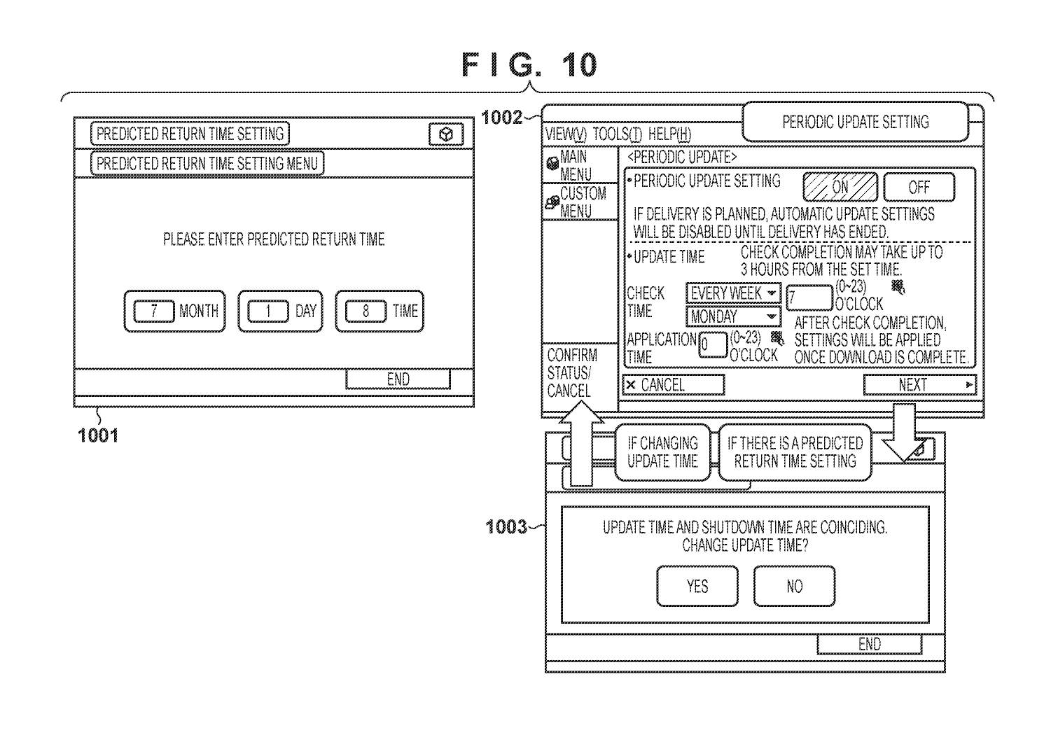

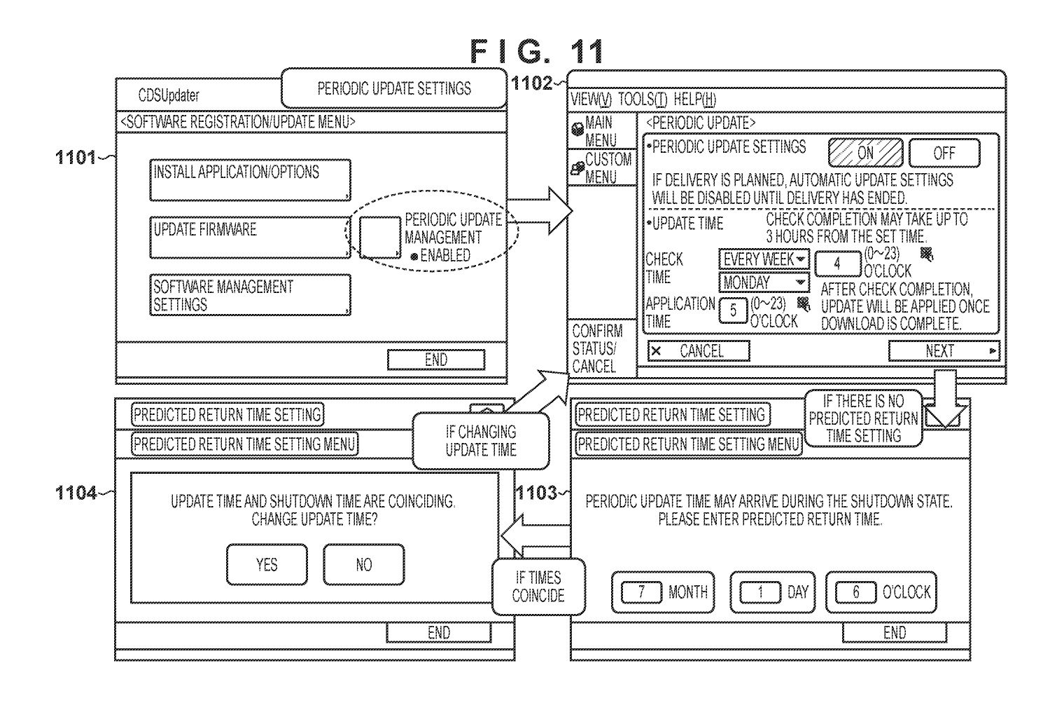

Next, with reference to FIGS. 10 and 11, an example of a display of the operation unit 220 of the information processing apparatus 100 according to the present embodiment will be described. In this case, more optimal power control is performed by allowing the user to input the time at which a standby return W2 is to be performed from the shutdown state, and holding that time of the standby return W2 (i.e., the predicted return time) in the SRAM 213. FIG. 10 shows a case in which a predicted return time is input before the periodic update time is set. FIG. 11 shows a case in which the user is prompted to perform settings when the predicted return time is not set in the SRAM 213 during the setting of the periodic update time.

FIG. 10 shows an example of a display of the operation unit 220 of the information processing apparatus 100 in a case in which a predicted return time is input before the setting of the periodic update time. A screen 1001 in FIG. 10 shows a display of the operation unit 220 during the setting of the predicted standby return time, in a case in which the information processing apparatus 100 is to be shut down. In the present embodiment, an example of a case is shown in which the predicted return time is set for July 1st, at 8 o'clock. This value is stored in the SRAM 213 by the CPU 210. This predicted return time is merely a predicted time, it is not such that a return is performed automatically, and it represents the predicted time that a user causes a standby return to be performed.

Similarly to the screen 602 in FIG. 6 of Embodiment 1, a screen 1002 is an example of a display of the operation unit 220 for allowing the periodic update time to be set. Here, the CPU 210 reads out settings of the predicted return time from the SRAM 213, and if there are settings, a screen 1003 in FIG. 10 is displayed. On the screen 1003, as shown in FIG. 9A, out of consideration for the fact that an update cannot be performed when the shutdown timing U is reached in the shutdown state, a screen for prompting the user to change the update time is displayed. In the case in which the user changes the update time, the “yes” button on the screen 1003 is pressed, the user returns to the screen 1002, and performs re-setting of the update time, but a case in which “no” is pressed and changes are not made is also possible. Also, the set time of shutdown and the predicted return time, or at least one of the two may be the time that is re-set.

FIG. 11 shows according to the present embodiment, an example of a display of the operation unit 220 of the information processing apparatus 100 of the present embodiment during a case in which a user is prompted to perform setting when a predicted return time is not set in the SRAM 213 during the setting of the periodic update time. Screens 1101 and 1102 are the same as the screens 601 and 602 in FIG. 6 of Embodiment 1. In a case where there are no predicted return time settings in the SRAM 213 when settings of periodic updates are performed on the screen 1102, a screen 1103 is displayed and the input of a predicted return time is prompted. The predicted return time set here is stored in the SRAM 213 by the CPU 210, but if the periodic update time is between the shutdown time and the predicted return time, a warning screen 1104 is displayed, similarly to the screen 1003 in FIG. 10. If the update time is to be changed, the user returns to the screen 1102 and performs re-setting, but a case in which change is not performed is also possible, similarly to the screen 1002 in FIG. 10.

Procedure of Shutdown Processing

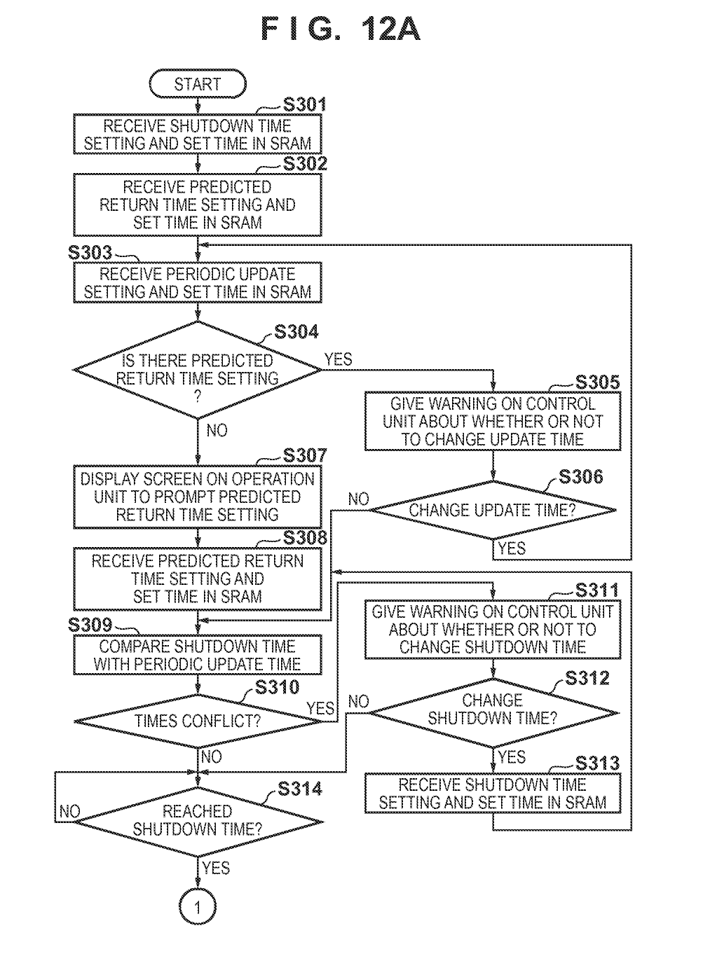

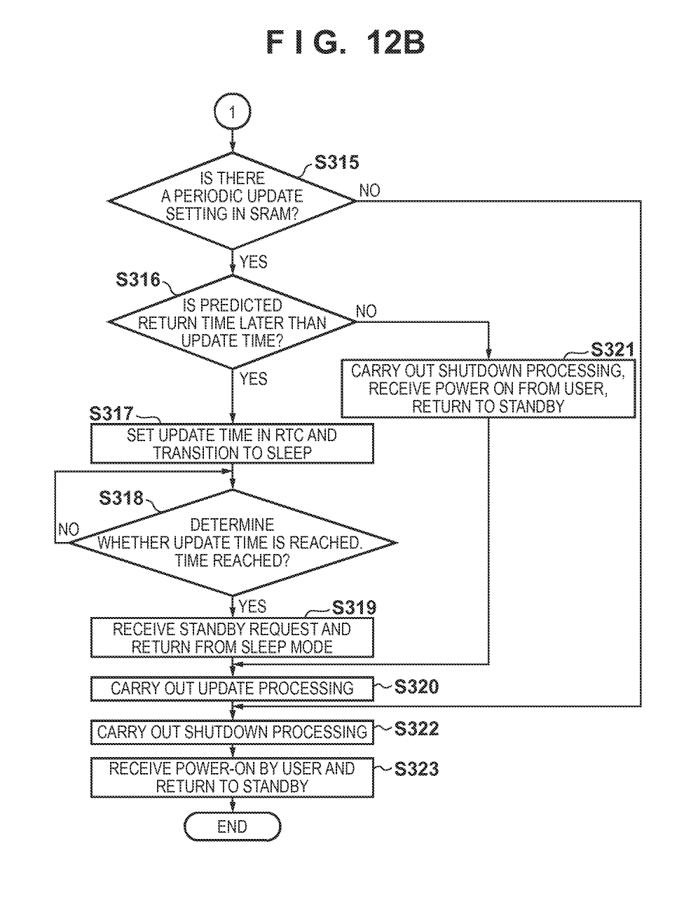

FIGS. 12A and 12B show a flowchart of a case in which power control is efficiently performed when the predicted return time is earlier than the update time when the shutdown timing is reached during a state in which periodic update processing has been scheduled. The procedure in FIGS. 12A and 12B is executed by the CPU 210.

In step S301, as shown in FIG. 7 of Embodiment 1, the CPU 210 receives shutdown settings from the user and sets the time in the SRAM 213. In step S302, as shown in the screen 1001 in FIG. 10, the CPU 210 stores the predicted return time in the SRAM 213, but as shown in FIG. 11, there are cases in which it is not set at this point in time. Next, as shown in the screen 1002 in FIG. 10 and the screen 1102 in FIG. 11, the CPU 210 receives periodic update settings from the user and sets the time in the SRAM 213 in step S303. Next, in step S304, it is determined whether or not the predicted return time is set in the SRAM 213. If it is set, the processing continues to step S305, and a warning about whether or not to change the update time is displayed on the operation unit 220 according to an instruction from the CPU 210, as shown in the screen 1003 in FIG. 10. In step S306, it is determined whether or not an instruction for changing the update time has arrived, and if a change will be performed, the processing returns to step S303. If a change will not be performed in step S306, the processing continues to step S309. If it is determined that a predicted return time has not been set in step S304, the processing continues to step S307, and as shown in the screen 1103 in FIG. 11, a screen that prompts the input of the predicted return time is displayed. In step S308, the CPU 210 causes the SRAM 213 to store the input time. In step S309, given that the time settings were set in steps S301 and S303, the CPU 210 reads out the periodic update time and the shutdown time from the SRAM 213 and compares the times. In step S310, it is determined whether or not the times that were compared in step S309 conflict with each other, and whether they are settings according to which the periodic update is to be performed after the shutdown time. In the case of an affirmative determination, the CPU 210 displays a warning about whether or not to change the time on the operation unit 220 in step S311, as shown in the screen 1104 in FIG. 11. In step S312, it is determined whether or not a change will be performed, and if a change will be performed, the CPU 210 receives the shutdown time setting again and re-sets the time in the SRAM 213 in step S313, and the processing returns to step S309. If a change will not be performed in step S312, the processing continues to step S314. In step S310, even if there is no time conflict, the processing continues to step S314. Steps from step S301 up to and including S313 are various types of time setting processes. Steps from step S314 onward are processes for when the set shutdown time has been reached, and they are executed asynchronously with steps S301 to S313.

In step S314, the time is read out in the RTC 270, and the CPU 210 determines whether the shutdown time has been reached. If the shutdown time has not been reached, step S314 is repeated. If the shutdown time has been reached, the processing continues to step S315, and it is determined whether a periodic update has been set in the SRAM 213 (timing SD1 in FIGS. 9B and 9C). If a periodic update has been set, the processing continues to step S316, and it is determined whether or not the predicted return time is later than the update time. In the case of an affirmative determination, the processing continues to step S317, the update time (return time for an update) is set in the RTC 270 as an alarm time, and a transition to the sleep state is performed. At this time, the sleep state is a state in which only some of the blocks in the information processing apparatus 100 are energized (e.g., a power consumption of about 1 W), as shown in FIG. 2 of Embodiment 1. Subsequently, the processing continues to step S318, and the RTC 270 determines whether or not the update time (return time for an update) has been reached. If it has not been reached, the determination is repeated. Note that, similarly to FIG. 8, if the alarm has been set as in the present example, step S318 is not necessary due to the processing being executed from step S319 using an alarm interrupt as a trigger.

If the update time has been reached, the processing continues to step S319, and a return from the sleep state (FIG. 2) to the standby state (FIG. 1) is performed according to an instruction from the CPU 210 (timing W1 in FIG. 9B). Then, subsequently, update processing is carried out according to an instruction from the CPU 210 in step S320. Then, when update processing has ended, shutdown is carried out according to an instruction from the CPU 210 in step S322 (here, 0 W is achieved) (timing SD2 in FIG. 9B). Also, if there is no periodic update setting in step S315, the processing continues to step S322, and shutdown is similarly carried out. Then, in step S323, a return to standby is performed when the user switches on the power (timing W2 in FIG. 9B). Also, if the predicted return time is earlier than the update time in step S316, the processing continues to step S321 in which shutdown is performed, and then if a switching on of power from the user is received, a return to standby is performed, and the processing continues to the processing of steps S320, S322, and S323 (in a manner similar to FIG. 9C). The fact that consideration is given to the predicted return time in addition to Embodiment 1 is a feature of the present embodiment, and excluding steps S302, S304 to S308, S316, and S321, which relate to the predicted return time, the steps in FIGS. 12A and 12B are basically the same as in FIG. 10.

According to the above procedure, in the present embodiment, in addition to effects that are similar to Embodiment 1, by giving consideration to the predicted return time as well, a scheduled update subsequent to a power return can be handled more efficiently, and power consumption can be further reduced.

### Embodiment 3

Embodiment 3 for implementing the present invention will be described below with use of the drawings. The present example mainly shows a case in which management of a schedule of a periodic update and a shutdown of an information processing apparatus that is communicably connected to an external server 250 is performed on the external server 250, in an office or the like that has multiple office machines (information processing apparatuses 100). In the present embodiment, scheduled updates are performed reliably by performing schedule adjustment.

Since the units in FIGS. 1, 2, 3, and 4 are similar to those of Embodiment 1, they will not be described.

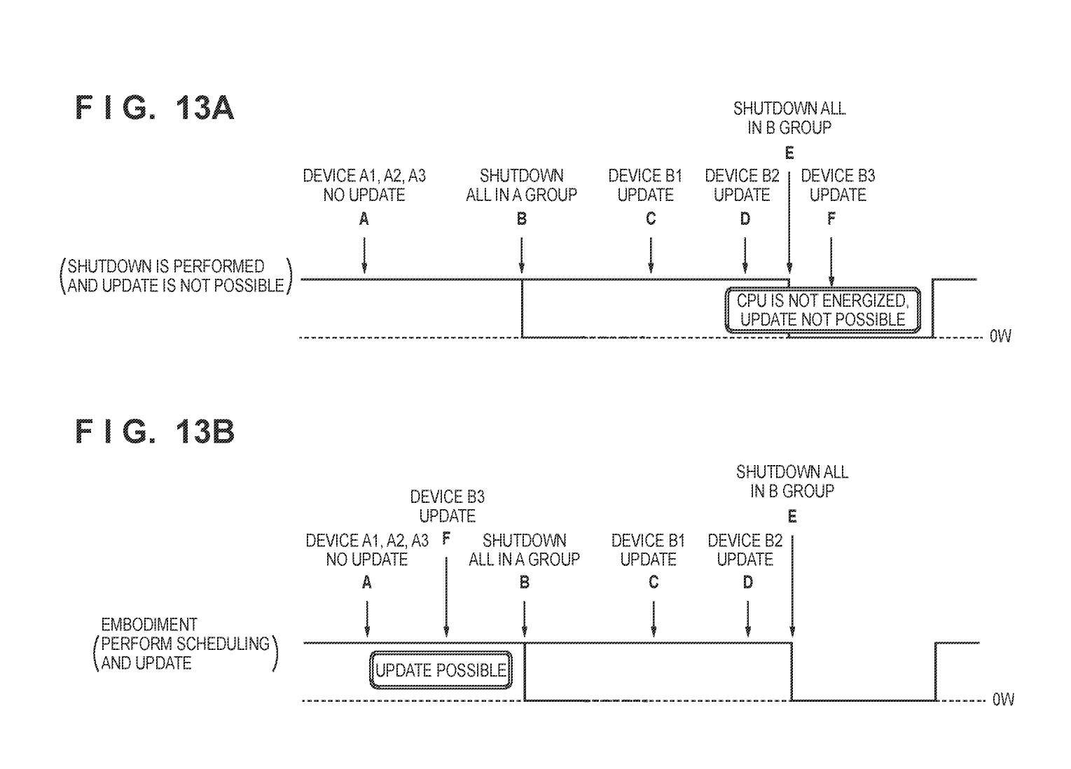

FIGS. 13A and 13B are examples of diagrams that show time charts of conventional information processing apparatuses 100. FIG. 13A is a time chart of when normal update processing and shutdown of multiple office machines (information processing apparatuses 100) are performed. For example, in the present embodiment, a case is envisioned in which office machines (information processing apparatuses 100) are divided into an A group (devices A1, A2, and A3) and a B group (devices B1, B2, and B3). For example, it is assumed that there is no update in the A group (timing A). In such a case, shutdown can be performed without incident in response to a request for a shutdown of all devices in the A group (timing B). Regarding the B group, since an update of device B1 (timing C) and an update of device B2 (timing D) are before a request for shutdown of all devices in the B group (timing E), the updates are successful. However, since an update of device B3 (timing F) is after the request for shutdown of all devices in the B group, the update of device B3 cannot be performed.

FIG. 13B is a timing diagram of the present embodiment, and it shows a time chart of a case in which the external server 250 has adjusted the timing of updates and shutdowns in view of the situation in FIG. 13A. By adjusting (i.e., re-scheduling) the update timing of device B3 (timing F) shown in in FIG. 13A that cannot be updated, to a time that is before the shutdown of all devices in the A group (B), it is possible to perform the update. According to this, the updating of office machines (information processing apparatuses 100) in the B group that need updating can be completed, and shutdown processing of both the A group and the B group can be completed.

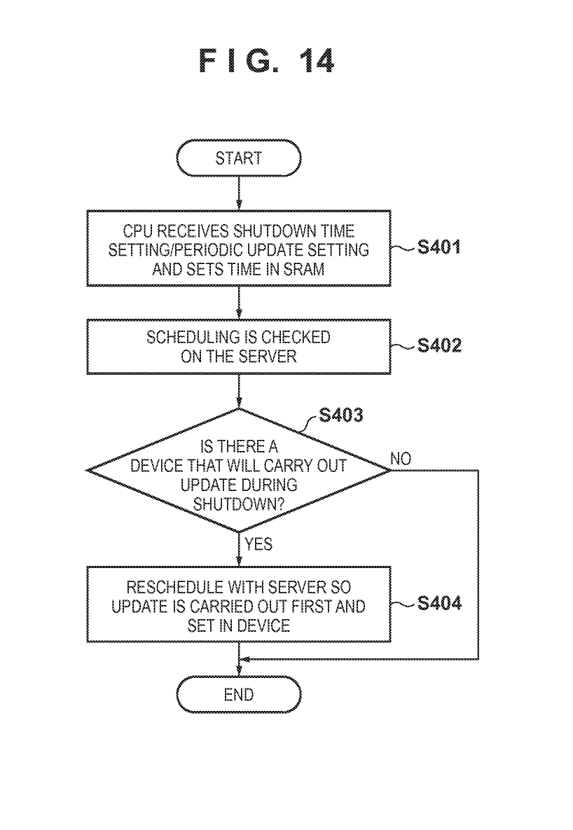

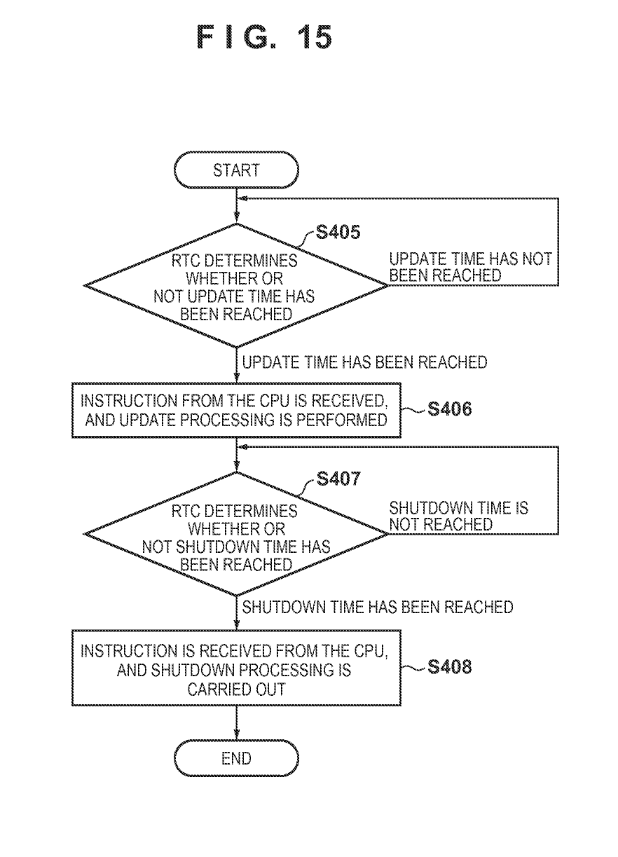

FIGS. 14 and 15 show flowcharts of cases in which the external server 250 shown in FIGS. 13A and 13B optimally adjusts the updates and shutdowns of multiple office machines (information processing apparatuses 100). Excluding step S401, FIG. 14 is a process flow performed by a server, and FIG. 15 is a procedure that is executed by an information processing apparatus.

In step S401 of FIG. 14, as described in Embodiment 1, the CPU 210 sets the shutdown time and the periodic update time in the SRAM 213. This setting is performed in the office machines (information processing apparatuses 100). In step S402, the status of update and shutdown scheduling of the office machines (information processing apparatuses 100) is checked by the external server 250. Specifically, the server polls the information processing apparatuses and reads the schedules of the apparatuses. In step S403, as shown in FIGS. 13A and 13B, the read and collected schedules of the information processing apparatuses are referenced, and it is determined whether or not there is a device in which an update is scheduled to a time that is during the shutdown state (i.e., whether or not update processing is to be performed after the shutdown time). In the case of an affirmative determination, in terms of FIG. 13A, it would be the device B3 for example, and in such a case, the external server 250 performs scheduling on the server such that the update is carried out before the shutdown in step S404. More specifically, the schedule is re-set such that the update time of the target device is at a time earlier than the shutdown time. Subsequently, out of the schedules, a set time relating to the device B3 is transmitted to the device B3, and setting is performed in the device B3. For example, as shown in FIG. 13B, the update timing (timing F) of the device B3 is adjusted to a time that is before the shutdown of all devices in A group (timing B). In step S403, if there is no such device, the processing ends. According to the procedure up to and including step S403, the adjustment, or re-setting of the schedule is complete. The procedure from step S405 onward is a procedure that is executed in each information processing apparatus.

In FIG. 15, in step S405, the RTC 270 determines whether or not the update time has been reached. If the time has been reached, an instruction from the CPU 210 is received, and update processing is performed in step S406. If the update time has not been reached, the processing of step S405 is repeated. When the update processing ends, the processing continues to step S407, and the RTC 270 determines whether or not the shutdown time has been reached. If the determination is affirmative, the processing continues to step S408, an instruction is received from the CPU 210, and shutdown processing is carried out. If the shutdown time is not reached in step S407, step S407 is repeated.

According to the above-described procedure and the present embodiment, the schedule of the scheduled update of each device and the schedule of auto-shutdown of each group of devices can be adjusted by a server, updates can be carried out without omission, and the reduction of power consumption can be realized.

### Other Embodiments

Additionally, the present invention is realized by the execution of the below-described process. More specifically, it is a process in which software (a program) that realizes functions of the aforementioned embodiments is supplied to a system or an apparatus via a network or various types of storage media, and a computer (or CPU, MPU, or the like) of the system or apparatus reads out the program and executes it.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-159077, filed Jul. 17, 2012, which is hereby incorporated by reference herein in its entirety.

What is claimed is:

1. An information processing apparatus having a sleep function that stops a supply of power to a part of the information processing apparatus excluding at least a clock unit, comprising:
a scheduled update unit configured to carry out program update processing at a scheduled update time;
an auto-shutdown unit configured to determine whether the update time is set if a shutdown condition is satisfied, sets an alarm time that is earlier than the update time in the clock unit and transitions to a sleep state using the sleep function if the update time is set, and if the update time is not set, stops a supply of power to the entire information processing apparatus; and
a return unit configured to cause the information processing apparatus to return from the sleep state to an operation state when the clock unit reaches the set alarm time,
wherein the auto-shutdown unit stops a supply of power to the entire information processing apparatus after a return from the sleep state is performed and update processing carried out by the scheduled update unit ends.

2. The information processing apparatus according to claim 1, further comprising:
an input unit configured to receive an input of a shutdown time as the shutdown condition, and if the update time is after the input shutdown time, further receives a re-setting of at least one of the shutdown time and the update time.

3. The information processing apparatus according to claim 1,
wherein, even in a case where the update time has been set, if a planned power-on time that was input in advance is earlier than the update time, the auto-shutdown unit stops the supply of power to the entire information processing apparatus.

4. The information processing apparatus according to claim 3, further comprising:
an input unit configured to receive an input of a shutdown time as the shutdown condition, and if the update time is after the input shutdown time and furthermore before the planned power-on time, receiving a re-setting of at least one of the shutdown time, the update time, and the planned power-on time.

5. The information processing apparatus according to claim 3, further comprising:
an input unit configured to receive an input of a shutdown time as the shutdown condition, and if the update time is after the input shutdown time, and furthermore the planned power-on time has not been input, receiving an input of the planned power-on time, and if the update time is before the input planned power-on time, receiving a re-setting of at least one of the shutdown time, the update time, and the planned power-on time.

6. A non-transitory computer-readable medium in which a program is recorded for causing an information processing apparatus that has a sleep function that stops a supply of power to a part of the information processing apparatus, excluding at least one clock unit, to function as:
scheduled update means for carrying out program update processing at a scheduled update time;
auto-shutdown means for determining whether the update time is set if a shutdown condition is satisfied, setting a time that is earlier than the update time in the clock unit and transitioning to a sleep state using the sleep function if the update time is set, and if the update time is not set, stopping a supply of power to the entire information processing apparatus; and
return means for causing the information processing apparatus to return from the sleep state to an operation state when the clock unit reaches the set time,
wherein the auto-shutdown means stops a supply of power to the entire information processing apparatus after a return from the sleep state is performed and update processing carried out by the scheduled update means ends.

7. A schedule adjustment method performed by an information processing apparatus that has a sleep function that stops a supply of power to a part of the information processing apparatus, excluding at least one clock unit, comprising:
carrying out program update processing at a scheduled update time;
determining whether the update time is set if a shutdown condition is satisfied, setting a time that is earlier than the update time in the clock unit and transitioning to a sleep state using the sleep function if the update time is set, and if the update time is not set, stopping a supply of power to the entire information processing apparatus; and
causing the information processing apparatus to return from the sleep state to an operation state when the clock unit reaches the set time,
wherein in the determining whether the update time is set, a supply of power to the entire information processing apparatus is stopped after a return from the sleep state is performed and update processing carried out in the scheduled update step ends.

8. A server that can be communicably connected with an information processing apparatus, the server comprising:
a unit configured to store a schedule that includes a shutdown time at which shutdown processing for stopping a supply of power to the information processing apparatus is performed, and an update time at which update processing for updating a program of the information processing apparatus is carried out;
a unit configured to determine, with reference to the schedule, whether the update processing is to be carried out after the shutdown time;
a unit configured to re-set the schedule such that, in a case where it is determined that the update processing is to be carried out after the shutdown time, the update time is earlier than the shutdown time; and
a unit configured to transmit the schedule to the information processing apparatus.

9. The server according to claim 8,
wherein the schedule includes an update time at which update processing is to be carried out for each of a plurality of information processing apparatuses, and a shutdown time at which shutdown processing is to be carried out for each of a plurality of groups into which the plurality of information processing apparatuses are divided.

10. A non-transitory computer-readable medium in which a program is recorded for causing a computer that can be communicably connected with an information processing apparatus to function as:
means for storing a schedule that includes a shutdown time at which shutdown processing for stopping a supply of power to the information processing apparatus is performed, and an update time at which update processing for updating a program of the information processing apparatus is carried out;
means for determining, with reference to the schedule, whether the update processing is to be carried out after the shutdown time;
means for re-setting the schedule such that, in a case where it is determined that the update processing is to be carried out after the shutdown time, the update time is earlier than the shutdown time; and
means for transmitting the schedule to the information processing apparatus.

11. A schedule adjustment method performed by a server that can be communicably connected to an information processing apparatus, comprising:
storing a schedule that includes a shutdown time at which shutdown processing for stopping a supply of power to the information processing apparatus is performed, and an update time at which update processing for updating a program of the information processing apparatus is carried out;
determining, with reference to the schedule, whether the update processing is to be carried out after the shutdown time;
re-setting the schedule such that, in a case where it is determined that the update processing is to be carried out after the shutdown time, the update time is earlier than the shutdown time; and
transmitting the schedule to the information processing apparatus.
